(19) United States
(12) Patent Application Publication
(10) Pub. No.: US 2016/0078785 A1
(43) Pub. Date: Mar. 17, 2016

(54) Method for Hiding Messages and Revealing Said Messages Utilizing Phosphorescent Devices

(71) Applicants: Jennifer Dana Leary, Raleigh, NC (US); Jonathan Bobrow, Somerville, MA (US)

(72) Inventors: Jennifer Dana Leary, Raleigh, NC (US); Jonathan Bobrow, Somerville, MA (US)

(21) Appl. No.: 14/855,051

(22) Filed: Sep. 15, 2015

Related U.S. Application Data
(60) Provisional application No. 62/051,284, filed on Sep. 16, 2014.

(51) Int. Cl. G09C 5/00

(52) U.S. Cl. CPC G09C 5/00

(57) ABSTRACT

An encryption method for an image, alphanumeric message, random pattern, or any other visual depiction is disclosed. Furthermore, a device for decoding the concealed message created in accordance with the aforementioned method is disclosed. The method and device rely on the limited range of light wavelengths which trigger phosphorescence in a given material. Those wavelengths can be combined with others to obscure the activating light pattern when viewed by the human eye.

### CROSS-REFERENCE TO RELATED APPLICATIONS

U.S. Provisional Patent Application Number 62/051,284, filed on Sep. 16, 2014.

### STATEMENT REGARDING FEDERALLY SPONSORED RESEARCH OR DEVELOPMENT

Not Applicable

### BACKGROUND OF THE INVENTION

The present invention is a novel method for creating hidden images. It is in the broad technical field of cryptography. More specifically, it conveys a technique for embedding visual information in digital images in a manner such that this information is not visually obvious. The present invention further describes a tool which is able to convert this information to a visible form, thereby decoding it.

Techniques for creating, sending, and revealing secret messages have wide-ranging applications. Many novelty items, such as board games and activity books, incorporate devices which allow for secret messages to be exchanged. “Invisible ink” pens and red-reveal lenses are central to game-play in many amusement products. Similar techniques and devices may also be applied in the field of anti-forgery and document authentication. In both high-security and low-security applications, widespread knowledge of the encryption technique compromises its effectiveness. The present invention presents an as-yet unknown technique, and thus responds to the continuous need for novel encryption techniques.

Unlike other methods which utilize phosphorescence to communicate messages (Published Applications WO 1998042518 A1, US 20060093777 A1), the present invention relies on the selective response of phosphorescent materials to signals of specific wavelength ranges. Although such a coupling has been previously described using specialized equipment for product authentication (U.S. Pat. No. 7,846,639), until now, this phenomenon could be used in conjunction with everyday consumer products to transmit messages. Here, a skilled method is described for integrating signals of specific wavelengths in visible images, such that the visible image conceals the signal. This provides the advantage of enabling users to encoding and decoding complex signals.

### BRIEF SUMMARY OF THE INVENTION

The present invention describes a method for obscuring a message (or series of messages) which a user desires to conceal in a digital flat panel display screen, and also describes a tool which allows the user to reveal this message (or messages) on an analog substrate. The message is thereby transferred off of the screen onto a different tangible surface, and this secondary surface does not require connection to a power source.

This method is based on the selective luminescence of phosphorescent pigments, which emit light when excited by a limited portion of the visible light spectrum. This novel method relies on this selectivity, which allows for a multi-color image on a digital device to be transformed by a secondary object coated with phosphorescent pigment. The coated object reveals a hidden message concealed within the image on the screen.

### BRIEF DESCRIPTION OF THE DRAWINGS

FIG. 1 is a top view of a device with a digital screen bearing an instance of this invention;

FIG. 2 is a perspective view of an alternative device with a digital screen bearing an instance of this invention;

FIG. 3 is a top view of one possible instance of the decoding tool of this invention;

FIG. 4 is a side view of the decoding tool of FIG. 3;

FIG. 5 is a perspective view of the decoding tool of FIG. 3;

FIG. 6 is a top view of another possible instance of the decoding tool of this invention;

FIG. 7 is a sequential illustration of the decoding tool of FIG. 3 as it decodes a message;

FIG. 8 is a sequential illustration of the decoding tool of FIG. 3 as it decodes a message;

FIG. 9 is a schematic of the decoding tool of FIG. 3 being used to decode a message on the device with a digital screen of FIG. 1.

### DETAILED DESCRIPTION OF THE INVENTION

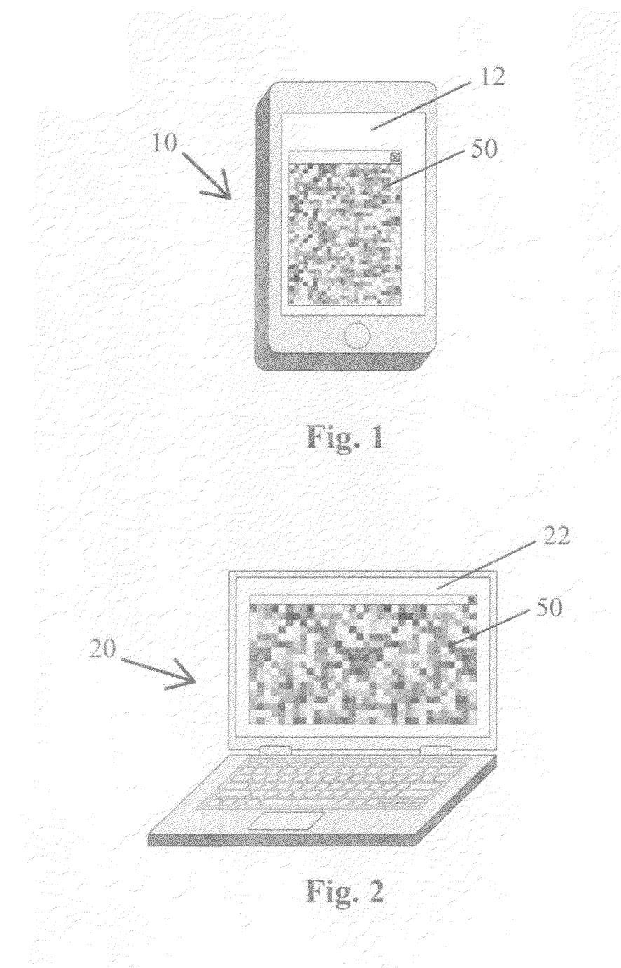

Referring now to the invention in more detail, in FIG. 1 there is shown a device 10 with a digital flat panel display screen 12 displaying an image 50. In FIG. 2 there is shown an alternative device 20 with a digital flat panel display screen 22 also displaying an image 50. The device 10, 20 may be a smart phone, laptop computer, tablet computer, television set, or any other electronic device with a flat panel display. The flat panel display 12, 22 may be a liquid crystal display, cathode ray tube, plasma display panel, light-emitting diode, or any other electronic visual display which emits multi-colored light.

In further detail, still referring to FIG. 1 and FIG. 2, the image 50 may show a pattern, picture, written message, random texture, or any other visual depiction composed of more than one color. In its preferred embodiment, the image 50 has additionally been programmed such that it contains an encrypted image. The encrypted image is a visual depiction of a pattern, picture, written message or any other image. The encrypted image and the primary image coexist in the same image plane, with the primary image being significantly more obvious to the human eye when viewing image 50 on the flat display screen 10, 20.

The construction details of the encrypted message as shown in FIG. 1 and FIG. 2 are that the image 50 is composed of thousands of pixels, each pixel having three sub-pixels with red, green, and blue color filters respectively. The intensity of light being emitted from each subpixel may be set to approximately 256 different levels by the voltage applied to individual electrodes. Thus the subpixels in each pixel combine to emit one of approximately 16 million unique colors (i.e. 256×256×256).

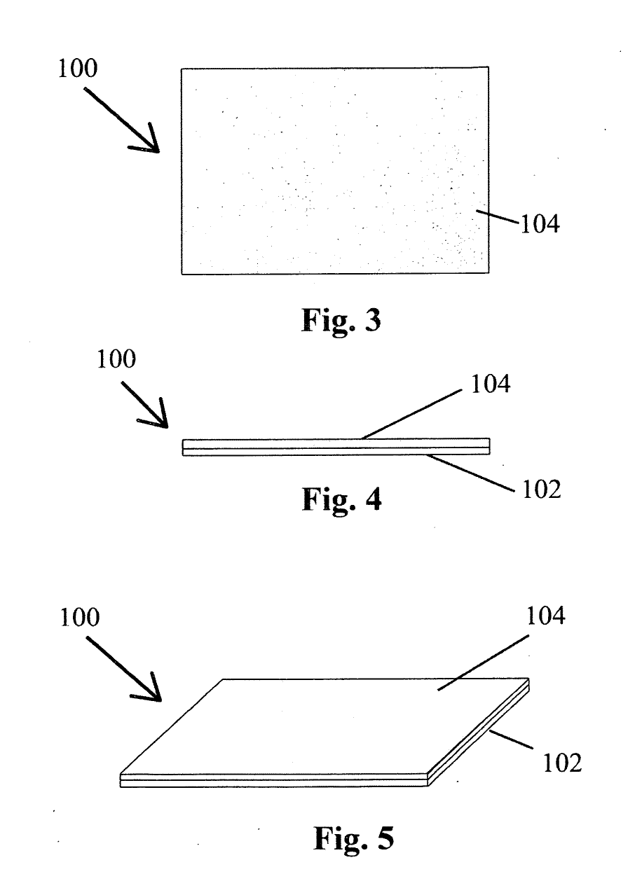

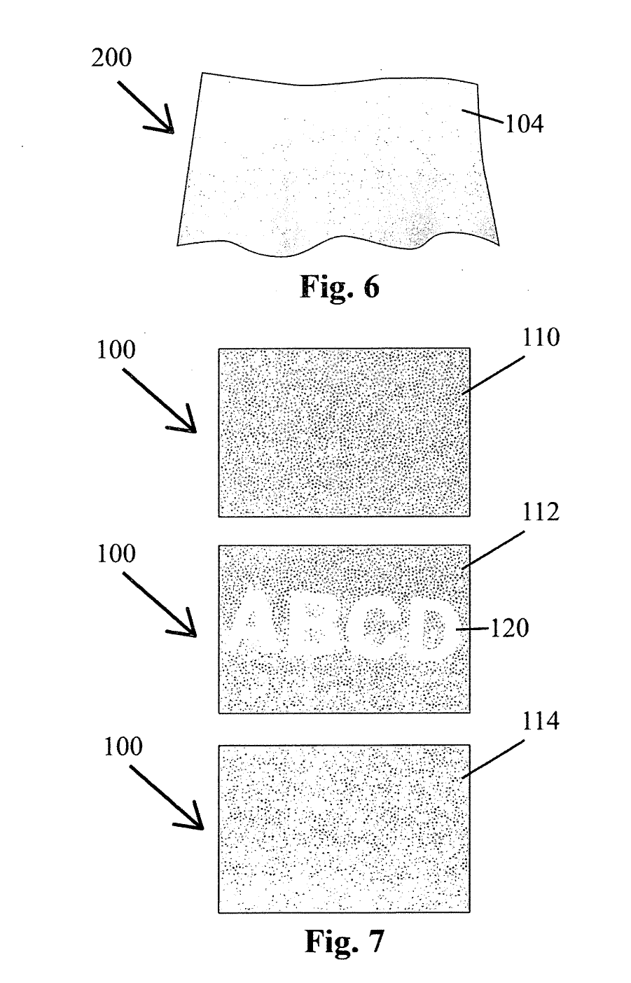

Referring now to FIG. 3-FIG. 5, there is shown a planar object 100 with a coating 104 applied to a substrate 102. The object 100 represents the decoding tool of the present invention. Referring now to FIG. 6, the coating 104 is shown to be applied to a piece of fabric, representing another embodiment of the decoding tool 200. The object 100, 200 may be a greeting card, a post-card, a shirt, a bag, a tissue cloth, a coaster, a box, or any other object with at least one planar surface.

In further detail, still referring to FIG. 3-FIG. 6, the coating 104 is made from a material containing phosphorescent pigments with sufficient quantum yield to be considered “glow in the dark” pigments. Examples of inorganic minerals which are used in phosphorescent paints are as follows, but are not limited to: zinc sulfate, strontium aluminate, and alkaline earth metal silicate. Powders derived from these minerals may be ground up and mixed with a polymer binder and solvent vehicle to create a paint-like substance so that the coating 104 may be adhered to the substrate 102 of the object 100, 200.

In still further detail, referring to the coating 104 shown in FIG. 3-FIG. 6, the coating 104 emits photons following exposure to photons of a certain wavelength. The emitted light is of always of a longer wavelength than the exciting light. In the preferred embodiment of this invention, the coating 104 is excited by photons in the range of 200-450 nm (ultraviolet-blue) and emits in the range of 500-550 nm (green). The emitted light is visible in the absence of intense light sources, for a time period dictated by the process of electrons returning to ground state.

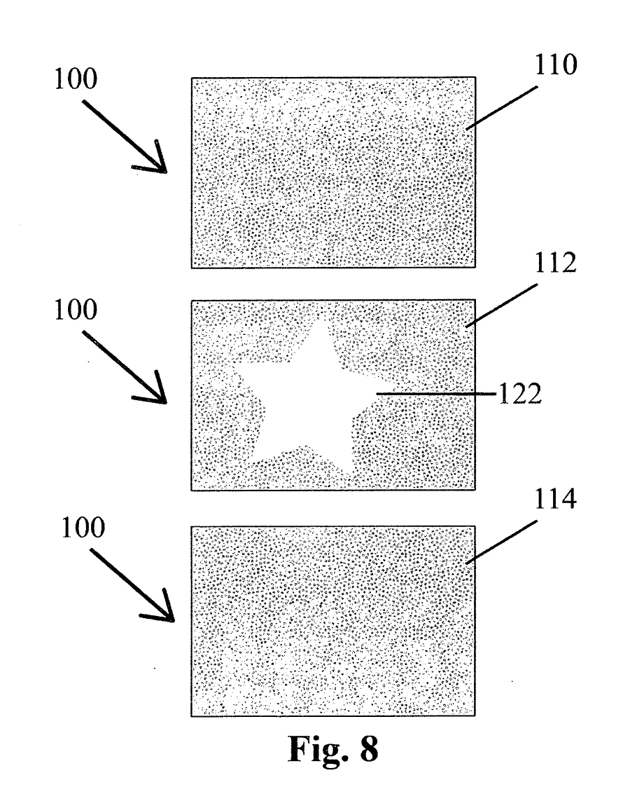

Referring now to FIG. 7 and FIG. 8 of the invention, the decoding tool 100 is shown in its pre-activated state 110, then in its activated state 112 and finally in its post-activated state 114. The pre-activated state 110 has not recently been exposed to photons in the exciting range, thus emits no light. The activated state 112 has recently been exposed to photons in the exciting range, in areas 120, 122 which represents glowing regions on the coating 104.

In further detail referring to FIG. 7 only, the activation source was in the form of the letters “ABCD” 120. Referring now to FIG. 8 only, the activation source was in the form of a star. Following the return of electrons to ground state, the coating is in the post-activated state 114 which is identical both in appearance and function to the pre-activated state 110. The image 120, 122 is thus shown to be a temporary mark.

In further detail referring to FIG. 7 and FIG. 8, the activation source may be of varying forms 120, 122. In both cases the mark 120,122 is shown to be temporary and can be followed by another mark of any shape. In both cases the coating 104 returns to a blank state 114 once the electrons have returned to ground state.

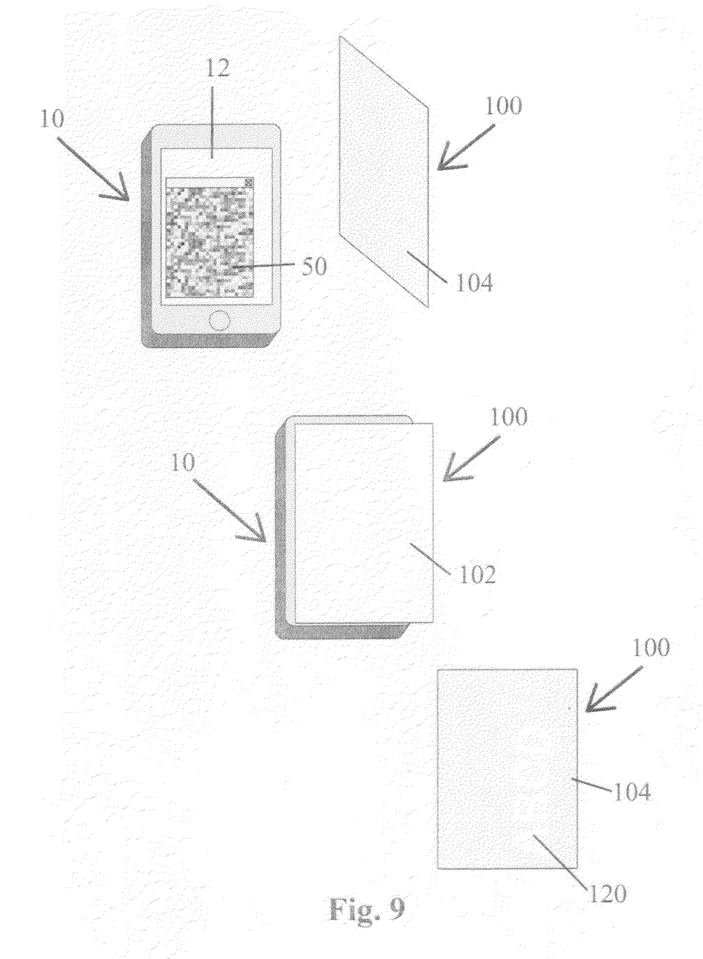

Referring now to FIG. 9 the decoding tool 100 is shown being used in conjunction with an image 50 on screen 12 of electronic device 10. It is intended that this is carried out in a dark room, in the absence of competing intense light sources. The decoding tool 100 must be pressed so that the coating 104 is in contact with the screen 12, and preferably is held in contact in this position for at least five seconds. Afterwards, the decoding tool 100 is separated from the screen 12 and flipped so that the user is able to see the coating 104. The encrypted message 120 appears as a glowing image on the coating on decoding tool 100.

In further detail, still referring to FIG. 9 of the present invention, as well as FIG. 1 and FIG. 2, the image 50 is programmed to contain an encrypted message 120. The encrypted message 120 is achieved by means of controlling the subpixel of each pixel which delivers light of the wavelength closest to the range which will activate the phosphorescent coating on the decoding tool 100. In the instance where the activating range is 200-450 nm, blue is the only subpixel out of red, green and blue which will trigger phosphorescence. Thus, by essentially isolating all of the blue subpixels, and not reacting to the red or the green subpixels, the decoding tool 100 is able to present the encrypted message 120 to the end user.

In broad embodiment, the present invention is a system for creating encrypted messages in multi-colored pixels on electronic flat display screens which can be decoded by means of a phosphorescent decoding tool.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method for hiding a message comprising:
obtaining a message to be hidden; the message being in a visible form which is composed of pixels;
converting all pixels to the same subpixel color channel, while varying the intensity level of each pixel such that the message is preserved;
obtaining a second image which will be used to obscure the first, also being in a visible form, composed of pixels;
ensuring that the pixels of the second image contain no amount of the subpixel color used for the first image, but are entirely composed of colors from yet-unused subpixel channels; and
combining the first set of pixels with the second set of pixels such that the intensity levels from the first set of pixels are included in the corresponding pixels of the second set.

2. The method of claim 1 wherein the hidden message comprises textual characters, images, patterns, or any combination of the above.

3. The method of claim 1 wherein the second image comprises textual characters, images, patterns, random colors, or any combination of the above.

4. The method of claim 1 wherein the final combined image appears so similar to the second image that the hidden message is effectively concealed from plain view.

5. The method of claim 1 further comprising preparation on a digital device with display screen composed of pixels, each individual pixel composed of a plurality of subpixels.

6. The method of claim 5 wherein the subpixel color channel chosen for the hidden message is of a wavelength that activates phosphorescence in an inorganic substance.

7. A method for revealing hidden images comprising:
loading a specially prepared image which contains a hidden message obscured by a second image onto a screen comprised of a multitude of pixels each containing a plurality of subpixels;
obtaining a decoding device with a planar surface coated with a material which is activated only by the hidden message, and pressing this surface against the screen while the specially prepared image is displayed on this screen; and
separating the decoding device from the screen such that the activated regions of the decoding device material may be seen.

8. The method of claim 7 wherein the hidden message within the specially prepared image is composed of color in a single subpixel color channel.

9. The method of claim 8 wherein the single subpixel color channel corresponds to a wavelength which activates phosphorescence in an inorganic substance.

10. The method of claim 9 wherein the inorganic substance is the material used to coat a planar surface of the decoding device.

11. The method of claim 7 wherein the planar surface of the decoding device is composed of fabric, paper, plastic, rubber, wood or any other common planar material which may support a phosphorescent coating.
